(19) United States
(12) Patent Application Publication
(10) Pub. No.: US 2011/0157161 A1
(43) Pub. Date: Jun. 30, 2011

(54) METHOD OF DISPLAYING STEREO-SCOPIC IMAGE AND DISPLAY APPARATUS FOR PERFORMING THE SAME

(75) Inventors: Hee-Jin CHOI, Seoul (KR); Jun-Pyo LEE, Asan-si (KR); Jung-Won KIM, Seoul (KR); Kwang-Hoon LEE, Anyang-si (KR)

(73) Assignee: SAMSUNG ELECTRONICS CO., LTD., Suwon-si (KR)

(21) Appl. No.: 12/963,974

(22) Filed: Dec. 9, 2010

(30) Foreign Application Priority Data
Dec. 24, 2009 (KR) 2009-0130374

(51) Int. Cl. G06T 15/00

(52) U.S. Cl. 345/419

(57) ABSTRACT

A method of displaying a stereoscopic image comprises; dividing an input image into a left-eye image and a right-eye image, estimating a crosstalk in accordance with a position of a display panel using a grayscale difference between the left-eye image and the right-eye image, displaying the left-eye image and the right-eye image and adjusting opening periods and closing periods of a pair of shutter glasses so that a shutter of the pair of shutter glasses is open and closed respectively during the opening period and the closing period based on the estimated crosstalk.

This application claims priority to Korean Patent Application No. 2009-130374, filed on Dec. 24, 2009, and all the benefits accruing therefrom under 35 U.S.C. §119, the content of which in its entirety is herein incorporated by reference.

### BACKGROUND OF THE INVENTION

1. Field of the Invention

Exemplary embodiments of the present invention relate to a method of displaying a stereoscopic image and a display apparatus for performing the method. More particularly, exemplary embodiments of the present invention relate to a method of displaying a shutter-glasses type stereoscopic image capable of enhancing display quality and a display apparatus for performing the method.

2. Description of the Related Art

Generally, a typical display device displays a two-dimensional (“2D”) image. Recently, a stereoscopic image display apparatus displaying a three-dimensional (“3D”) stereoscopic image has been developed according to increasing demands for the 3D stereoscopic image in fields such as games, movies and other display fields.

Generally, a typical stereoscopic image display device displays a three-dimensional (“3D”) image using a principle of binocular parallax through two eyes of a user. For example, since two eyes of a user are spaced apart from each other, images viewed at the different viewing angles of the two eyes are input to a brain of the user. The typical stereoscopic image display device thus generates a 3D image which includes two slightly different images, one image for each eye of the user. Thus, the observer may watch the 3D image to recognize the stereoscopic image through the display device.

The typical stereoscopic image display device is classified into a stereoscopic type display device which includes a pair of spectacles and an auto-stereoscopic type display device without the pair of spectacles. The stereoscopic type display device includes an anaglyph type, a liquid crystal shutter stereoscopic type and various other display devices. In the typical anaglyph type stereoscopic display device, glasses with blue and red color filters, one color for each eye, are worn by a viewer. In the typical liquid crystal shutter stereoscopic display device, a left image and a right image are temporally divided to be periodically, and sequentially, displayed, and the viewer wears a pair of glasses which sequentially open or close a left-eye liquid crystal shutter and a right-eye liquid crystal shutter in synchronicity with a period of the left and right images.

The liquid crystal display device (“LCD”) device is driven by a progressive scan method so that timings at which line data for each frame (e.g., a frame for a left-eye image and a right-eye image) are applied to horizontal lines of the LCD respectively, are different from one another, i.e., the timing at which line data for the frame for a left-eye image is different from the timing at which line data for the frame for the right-eye image, and thus response times of liquid crystal respectively corresponding to the horizontal lines of the different frames are different from one another. Accordingly, when the LCD device of the progressive scan method alternately displays the left-eye image and the right-eye image to display a stereoscopic image, a crosstalk is caused by a grayscale difference between the left-eye image and the right-eye image and a timing difference between a period during which the left-eye image is displayed on the LCD and a period during which the right-eye image is displayed on the LCD. The display quality of the stereoscopic image may be decreased by the crosstalk.

### BRIEF SUMMARY OF THE INVENTION

Exemplary embodiments of the present invention provide a method of displaying a stereoscopic image capable of decreasing a crosstalk of a stereoscopic image.

Exemplary embodiments of the present invention also provide a display apparatus for performing the above-mentioned method.

According to an exemplary embodiment of the present invention, there is provided a method of displaying a stereoscopic image. In the method, an input image is divided into a left-eye image and a right-eye image. A crosstalk is estimated in accordance with a position of a display panel using a grayscale difference between the left-eye image and the right-eye image. The left-eye image and the right-eye image are displayed. An opening period and a closing period are adjusted, a shutter of a pair of shutter glasses is open and closed respectively during the opening period and closing period based on the estimated crosstalk.

According to another exemplary embodiment of the present invention, a display apparatus includes a display panel, a pair of shutter glasses and a stereoscopic image converting part. The display panel displays a left-eye image and a right-eye image. The shutter glasses include a left shutter and a right shutter and selectively opens and closes the left shutter and the right shutter according to an image displayed on the display panel. The stereoscopic image converting part divides an input image into the left-eye image and the right-eye image, estimates a crosstalk in accordance with a position of the display panel using a grayscale difference between the left-eye image and the right-eye image, and adjusts an opening period and a closing period of the left shutter and the right shutter based on the estimated crosstalk.

According to a method of displaying a stereoscopic image and a display apparatus for performing the method, the crosstalk that is caused by a grayscale difference between the left-eye image and the right-eye image, is estimated in accordance with a position of a display panel, and opening and closing periods of the shutter glasses are adjusted based on the estimated crosstalk, so that the crosstalk being viewed by a viewer may be decreased.

### BRIEF DESCRIPTION OF THE DRAWINGS

The above and other features and advantages of the present invention will become more apparent by describing in detailed example embodiments thereof with reference to the accompanying drawings, in which:

FIG. 1 is a block diagram illustrating an exemplary embodiment of a display apparatus according to the present invention;

FIGS. 2A to 2E are schematic diagrams showing an exemplary embodiment of a method of driving an exemplary embodiment of a light source module of FIG. 1;

FIGS. 3A to 3D are schematic diagrams showing various driving examples of an exemplary embodiment of a dividing part of FIG. 1;

FIG. 4 is a timing diagram illustrating an exemplary embodiment of a method of displaying a stereoscopic image when a crosstalk at a first position of the exemplary embodiment of a display panel shown in FIG. 1 is at a maximum;

FIG. 5 is a timing diagram illustrating an exemplary embodiment of a method of displaying the stereoscopic image when the crosstalk of a second position of the exemplary embodiment of a display panel shown in FIG. 1 is at a maximum; and

FIG. 6 is a timing diagram illustrating an exemplary embodiment of a method of displaying the stereoscopic image when the crosstalk of a third position of the exemplary embodiment of a display panel shown in FIG. 1 is at a maximum.

### DETAILED DESCRIPTION OF THE INVENTION

The present invention is described more fully hereinafter with reference to the accompanying drawings, in which exemplary embodiments of the present invention are shown. The present invention may, however, be embodied in many different forms and should not be construed as limited to the exemplary embodiments set forth herein. Rather, these exemplary embodiments are provided so that this disclosure will be thorough and complete, and will fully convey the scope of the present invention to those skilled in the art. Like reference numerals refer to like elements throughout

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments of the invention are described herein with reference to cross-sectional illustrations that are schematic illustrations of idealized example embodiments (and intermediate structures) of the present invention. As such, variations from the shapes of the illustrations as a result, for example, of manufacturing techniques and/or tolerances, are to be expected. Thus, example embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be explained in detail with reference to the accompanying drawings.

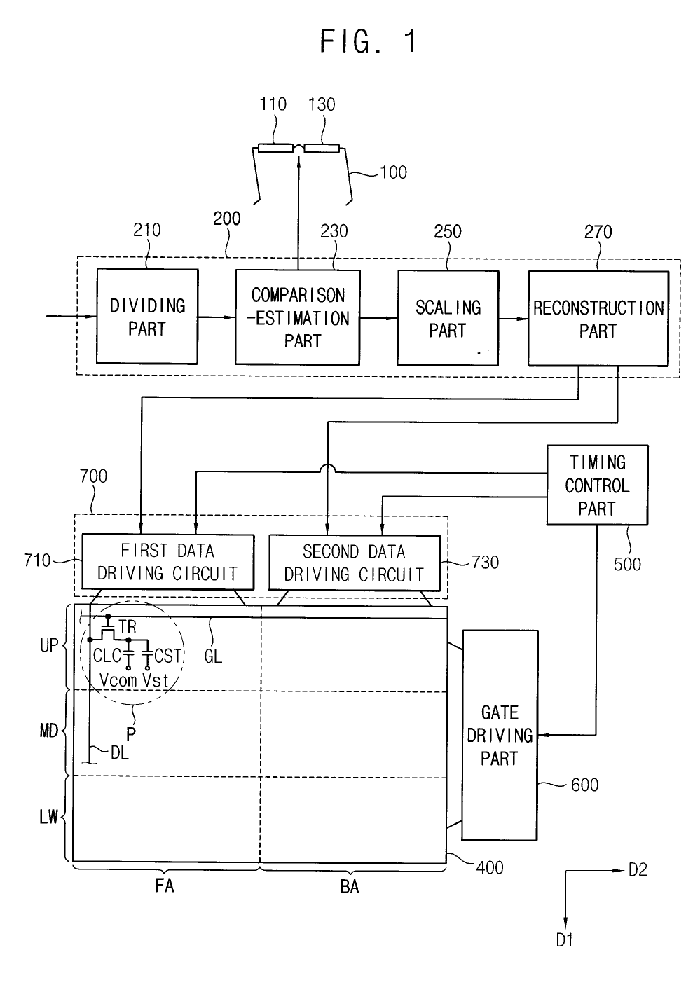

FIG. 1 is a block diagram illustrating an exemplary embodiment of a display apparatus according to the present invention.

Referring to FIG. 1, the display apparatus includes shutter glasses 100, a stereoscopic image converting part 200, a display panel 400, a timing control part 500, a gate driving part 600 and a data driving part 700.

The shutter glasses 100 include a left shutter 110 and a right shutter 130. For example, in one exemplary embodiment each of the left shutter 110 and the right shutter 130 may be a liquid crystal shutter. The shutter glasses 100 selectively open and close the left shutter 110 and the right shutter 130 according to an image displayed on the display panel 400.

The stereoscopic image converting part 200 converts an input image into a left-eye image and a right-eye image to display a stereoscopic image to a user. The stereoscopic image converting part 200 includes a dividing part 210, a comparison-estimation part 230, a scaling part 250 and a reconstruction part 270.

The dividing part 210 divides the input image into a compression left-eye image and a compression right-eye image. The input image includes information regarding the compression left-eye image and the compression right-eye image. For example, in one exemplary embodiment the input image has a full high-definition (“FHD”) resolution of 1920×1080 and includes the compression left-eye image and the compression right-eye image compressed in at least one of a side by side method, a vertical interleave method, a horizontal interleave method, a top-bottom method, or various other methods.

The comparison-estimation part 230 compares a grayscale of the compression left-eye image with a grayscale of the compression right-eye image and estimates a crosstalk in accordance with a position of the display panel 400. As described briefly above, the crosstalk is caused by a grayscale difference between the compression left-eye image and the compression right-eye image. The display panel 400 is divided into a plurality of positions along an image scanning direction D1 which is a direction in which an image is displayed on the display panel 400. For example, the display panel 400 is divided into a first position UP, a second position MD and a third position LW. The comparison-estimation part 230 controls opening and closing periods of the shutter glasses 100, so that shutters 110 and 130 of the shutter glasses 100 are open and closed.

For example, when a grayscale difference between the compression left-eye image and the compression right-eye image displayed on the first position UP, is the largest, the comparison-estimation part 230 controls the shutter glasses 100 to open the left shutter 110 and to close the right shutter 130 in synchronization with displaying the left-eye image on the first position UP of the display panel 400. In addition, the comparison-estimation part 230 controls the shutter glasses 100 to open the right shutter 130 and to close the left shutter 110 in synchronization with displaying the right-eye image on the first position UP of the display panel 400.

Therefore, the comparison-estimation part 230 compares grayscales of the compression left-eye image with grayscales of the compression right-eye image, estimates the crosstalk in accordance with the first, second and third positions UP, MD and LW of the display panel 400 in real time and controls the opening and closing periods of the shutter glasses 100, so that the crosstalk caused by the grayscale difference between the compression left-eye images and the compression right-eyes image may be decreased.

The scaling part 250 scales the compression left-eye image and the compression right-eye image up to a resolution of the display panel 400, e.g., 1920 by 1080, respectively, so that it generates a left-eye frame image and a right-eye frame image, respectively.

The reconstruction part 270 divides a frame image, e.g., a left-eye frame image or a right-eye frame image, into a first sub-image and a second sub-image. For example, in the present exemplary embodiment the display panel 400 is divided into a first area FA and a second area BA along a direction D2 substantially perpendicular to the image scanning direction D1. Thus, the reconstruction part 270 divides the left-eye frame image into a first sub-left-eye image corresponding to the first area FA and a second sub-left-eye image corresponding to the second area BA. In addition, the reconstruction part 270 divides the right-eye frame image into a first sub-right-eye image corresponding to the first area FA and a second sub-right-eye image corresponding to the second area BA. The reconstruction part 270 groups the first sub-left-eye image and the first sub-right-eye image together so as to provide them to the data driving part 700, and groups the second sub-left-eye image and the second sub-right-eye image together so as to provide them to the data driving part 700.

The display panel 400 includes a plurality of data lines DL which extend along the first direction D1 and arranged substantially perpendicular to the second direction D2, a plurality of gate lines GL which extend along the second direction D2 and are arranged substantially perpendicular to the first direction D1 and a plurality of pixels P corresponding to the resolution of the display panel 400, e.g., in one exemplary embodiment the resolution may be FHD at 1920 by 1080. Each pixel P of the plurality of pixels includes a thin-film transistor (“TFT”) TR connected to a data line DL and a gate line GL which are disposed substantially perpendicular to each other, a liquid crystal capacitor CLC connected to the TFT TR and a storage capacitor CST connected to the liquid crystal capacitor CLC. In one exemplary embodiment, the storage capacitor CST may be omitted.

In the present exemplary embodiment, the display panel 400 displays an image using the progressive scan method.

The timing control part 500 controls a driving timing of the gate driving part 600 and the data driving part 700. The timing control part 500 controls the data driving part 700 so that the data driving part 700 displays a black frame image on the display panel 400.

For example, since the left-eye frame image is displayed on the display panel 400, the data driving part 700 also displays the black frame image on the display panel 400. Since the right-eye frame image is displayed on the display panel 400, the data driving part 700 also displays the black frame image on the display panel 400.

The gate driving part 600 generates a plurality of gate signals to sequentially provide the gate lines GL with the gate signals according to the progressive scan method.

In the present exemplary embodiment, the data driving part 700 includes a first data driving circuit 710 and a second data driving circuit 730. The first data driving circuit 710 displays a first sub-image on the first area FA of the display panel 400, and the second data driving circuit 730 displays a second sub-image on the second area BA of the display panel 400.

For example, during a first sub-frame of a frame, the first data driving circuit 710 outputs a data of the first sub-left-eye image to the first area FA of the display panel 400 and the second data driving circuit 730 outputs a data of the second sub-left-eye image to the second area BA of the display panel 400. Thus, in the first sub-frame, a data of the left-eye frame image is provided to the display panel 400.

During a second sub-frame of the frame, the first and second data driving circuits 710 and 730 output a data of the black frame image to the first and second areas FA and BA according to a control of the timing control part 500.

During a third sub-frame of the frame, the first data driving circuit 710 outputs a data first sub-right-eye image to the first area FA of the display panel 400 and the second data driving circuit 730 outputs a data of the second sub-right-eye image to the second area BA of the display panel 400. Thus, in the third sub-frame, a data of the right-eye frame image is provided to the display panel 400.

During a fourth sub-frame of the frame, the first and second data driving circuits 710 and 730 output the data of the black frame image to the first and second areas FA and BA according to a control of the timing control part 500.

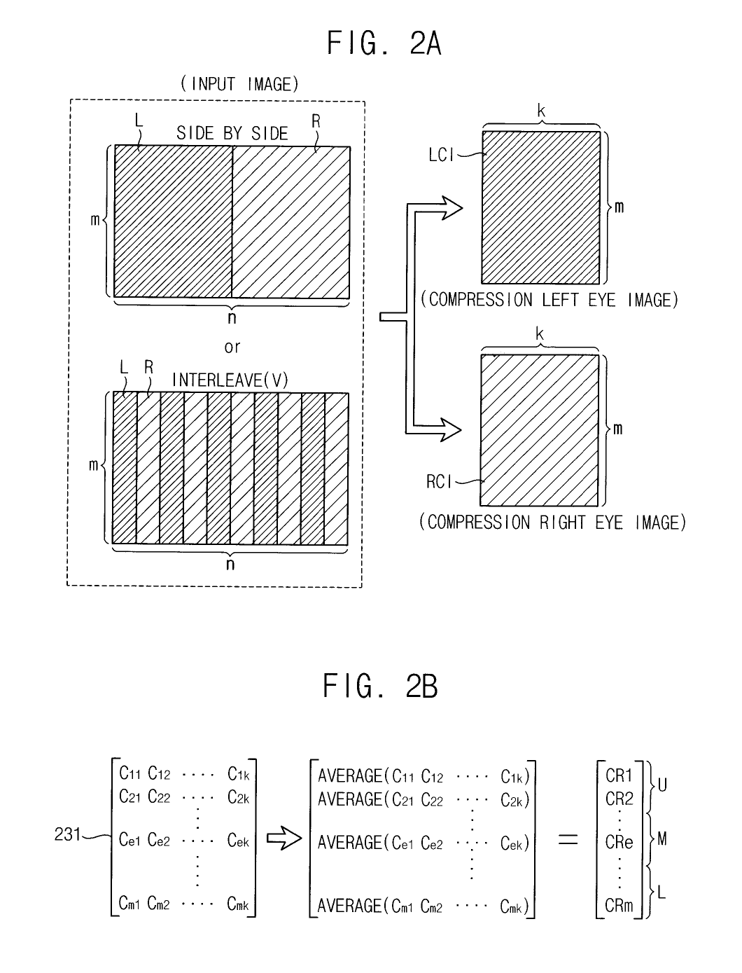

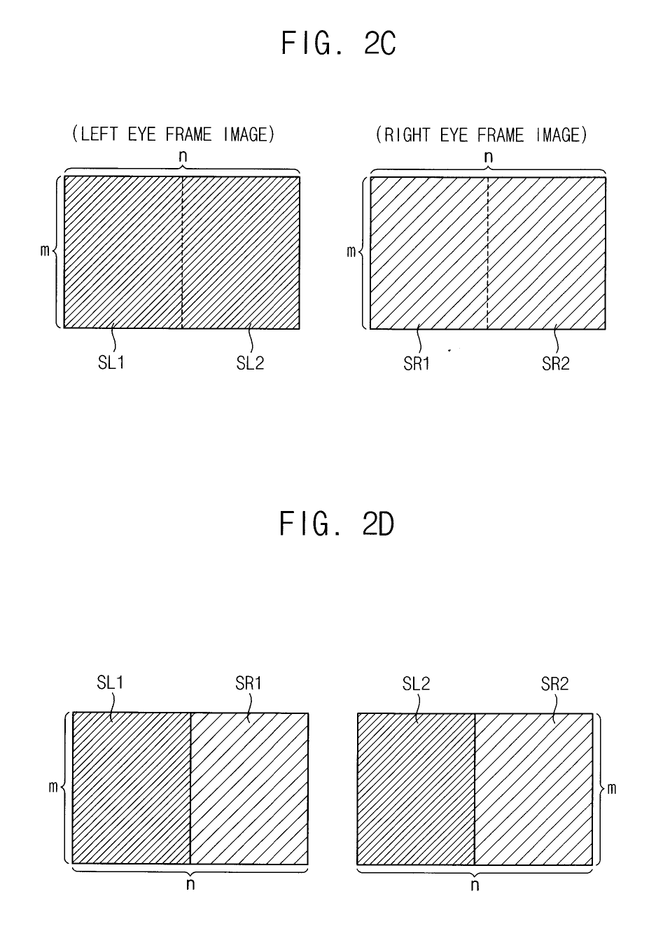

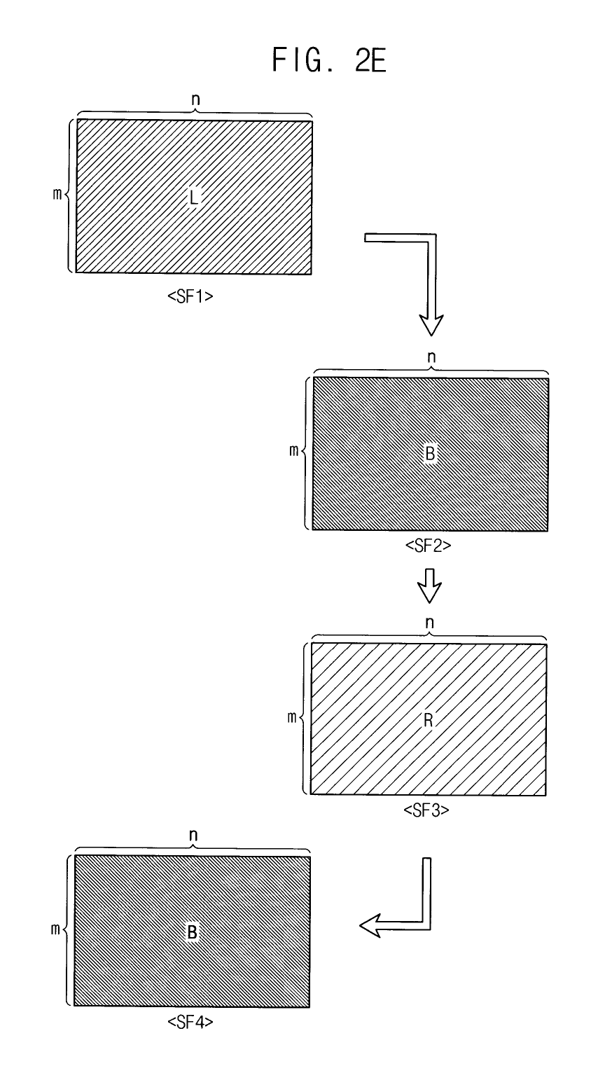

FIGS. 2A to 2E are schematic diagrams showing an exemplary embodiment of a method of driving a light source module of FIG. 1.

Referring to FIGS. 1 and 2A, the dividing part 210 divides the input image having a resolution of (n×m) into the compression left-eye image LCI having a resolution of (k×m) and the compression right-eye image RCI having a resolution of (k×m), wherein, n, m, k and e are natural numbers, and k is n/2. As shown in FIG. 2A, the input image includes the compression left-eye image LCI and the compression right-eye image RCI compressed by the side-by-side method or the vertical interleave method. In such an exemplary embodiment, each of the compression left-eye image LCI and the compression right-eye image RCI is an image that is compressed in a horizontal direction.

The comparison-estimation part 230 obtains the grayscale difference Cmk between the grayscale of the compression left-eye image LCI and the grayscale of the compression right-eye image RCI. The grayscale difference Cmk is defined by the following Equation 1.

Cmk=α×(Lmk−Rmk) <Equation 1>

Wherein α is a constant corresponding to a response time of the liquid crystal, is an integral number wherein 0<α<1 and is decreased when the response time is increased. Lmk is a grayscale value of a k-th position in a row direction and an m-th position in a column direction among the grayscale values of the compression left-eye image LCI. Rmk is a grayscale value of a k-th position in the row direction and a grayscale of an m-th position in the column direction among the grayscale values of the compression right-eye image RCI.

Each of the compression left-eye image LCI and the compression right-eye image RCI includes (k×m) grayscale values arranged in a matrix. Thus, a plurality of grayscale differences of the left-eye compression LCI and compression right-eye image RCI are defined to a grayscale difference matrix 231 of (k×m) as shown in FIG. 2B, wherein e is m/2.

The comparison-estimation part 230 obtains m crosstalk values CR1, CR2, . . . , CRe, . . . , CRm through an operation of the grayscale difference matrix 231 on an average matrix. Each of the crosstalk values CR1, CR2, . . . , CRe, . . . , CRm is an average value of the grayscale differences in each of rows of the grayscale difference matrix 231. The comparison-estimation part 230 groups the crosstalk values CR1, CR2, . . . , CRe, . . . , CRm into a first group U, a second group M and a third group L respectively corresponding to the first position UP, the second position MD and the third position LW. Each of the first, second and third groups U, M and L includes m/3 crosstalk values. The comparison-estimation part 230 compares a reference value CRth with each of the m/3 crosstalk values in each of the first, second and third groups U, M and L. The reference value CRth may be changed according to a physical property of the liquid crystal used in the display.

The comparison-estimation part 230 detects a group that has the most number of crosstalk values larger than the reference value CRth and estimates that the greatest amount of crosstalk due to the grayscale difference of the left-eye image and the right-eye image to be at a position of the display panel 400 corresponding to the detected group. The comparison-estimation part 230 controls the opening and closing periods of the left shutter 110 and the right shutter 130 in the shutter glasses 100 based on the estimated position of the greatest crosstalk.

For example, when the number of crosstalk values larger than the reference value CRth is the greatest within the first group U, the comparison-estimation part 230 opens the left shutter 110 and the right shutter 130 closes in synchronization with displaying of the left-eye image on the first position UP and opens the right shutter 130 and closes the left shutter 110 in synchronization with displaying of the right-eye image on the first position UP.

When the number of crosstalk values larger than the reference value CRth is the greatest within the third group L, the comparison-estimation part 230 opens the left shutter 110 and closes the right shutter 130 in synchronization with displaying of the left-eye image on the third position LW and opens the right shutter 130 and closes the left shutter 110 in synchronization with displaying of the right-eye image on the third position LW.

When the number of crosstalk values larger than the reference value CRth is the greatest at the second group M, or is uniform in the first to third groups U, M and L, the comparison-estimation part 230 opens the left shutter 110 and closes the right shutter 130 in synchronization with displaying the left-eye image on the second position MD and opens the right shutter 130 and closes the left shutter 110 in synchronization with displaying the right-eye image on the second position MD.

Therefore, the comparison-estimation part 230 compares the crosstalk values CR1, CR2, . . . , CRe, . . . , CRm with the reference value CRth, estimates the crosstalk corresponding to each position of the display panel 400 in real time and controls the opening and closing periods of the shutter glasses 100 based on the estimated crosstalk, so that the crosstalk being viewed by the viewer may be decreased.

Referring to FIGS. 1 and 2C, the scaling part 250 scales the compression left-eye image LCI and the compression right-eye image RCI up to a full resolution, e.g., 1920×1080, of the display panel 400, respectively, so as to generate the left-eye frame image and the right-eye frame image, respectively. The left-eye frame image L includes the first sub-left-eye image SL1 displayed on the first area FA of the display panel 400 and the second sub-left-eye image SL2 displayed on the second area BA of the display panel 400. In addition, the right-eye frame image R includes the first sub-right-eye image SR1 and the second sub-right-eye image SR2.

Referring to FIGS. 1, 2C and 2D, the reconstruction part 270 divides the left-eye frame image L into the first sub-left-eye image SL1 corresponding to a first area FA of the display panel 400 and the second sub-left-eye image SL2 corresponding to a second area BA. In addition, the reconstruction part 270 divides the right-eye frame image R into the first sub-right-eye image SR1 corresponding to the first area FA of the display panel 400 and the second sub-right-eye image SR2 corresponding to the second area BA.

The reconstruction part 270 groups the first sub-left-eye image SL1 and the first sub-right-eye image SR1 together and provides the first sub left-eye image SL1 and the first sub right-eye image SR1 to the data driving part 700. The reconstruction part 270 groups the second sub left-eye image SL2 and the second sub right-eye image SR2 together and provides the second sub left-eye image SL2 and the second sub right-eye image SR2 to the data driving part 700.

Referring to FIGS. 1 and 2E, during the first sub-frame SF1 of the frame, the first data driving circuit 710 displays the first sub-left-eye image SL1 on the first area FA of the display panel 400 and the second data driving circuit 730 displays the second sub-left-eye image SL2 on the second area BA of the display panel 400. Thus, during the first sub-frame, the left-eye frame image L is displayed on the display panel 400.

During the second sub-frame SF2 of the frame, the first and second data driving circuits 710 and 730 display a black frame image B on the first and second areas FA and BA according to a control of the timing control part 500.

During the third sub-frame SF3 of the frame, the first data driving circuit 710 displays the first sub right-eye image SR1 on the first area FA of the display panel 400 and the second data driving circuit 730 displays the second sub right-eye image SR2 on the second area BA of the display panel 400. Thus, during the third sub-frame, the right-eye frame image R is displayed on the display panel 400.

During the fourth sub-frame SF4 of the frame, the first and second data driving circuits 710 and 730 display the black frame image B on the first and second areas FA and BA according to a control of the timing control part 500.

Essentially, when the reconstruction part 270 groups the first sub-left-eye image SL1 and the first sub-right-eye image SR1 together, it is constructing a data packet to send to the first data driving circuit 710, wherein the first sub-left-eye image SL1 and the first sub-right-eye image SR1 will be sequentially displayed by the first data driving circuit 710 with a black image disposed therebetween. A similar data packet is prepared with the second sub-left-eye image SL2 and the second sub-right-image SR2 and sent to the second data driving circuit 730 for display in a similar manner.

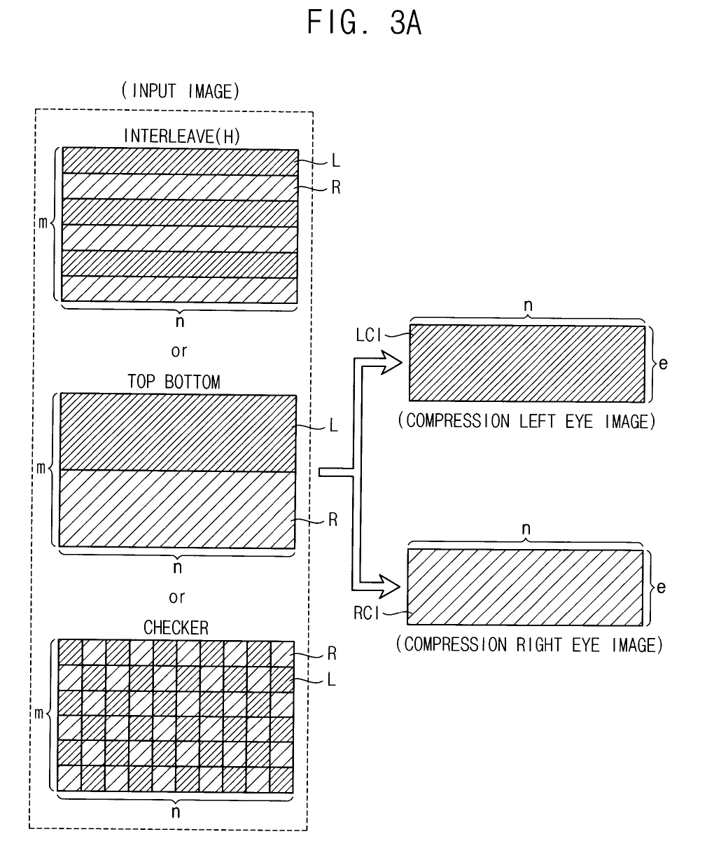

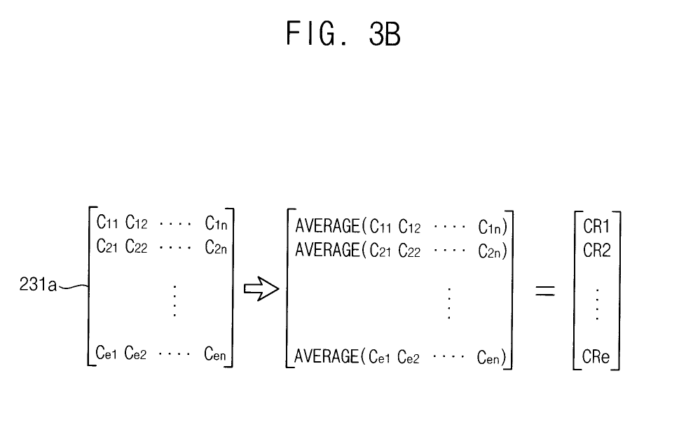

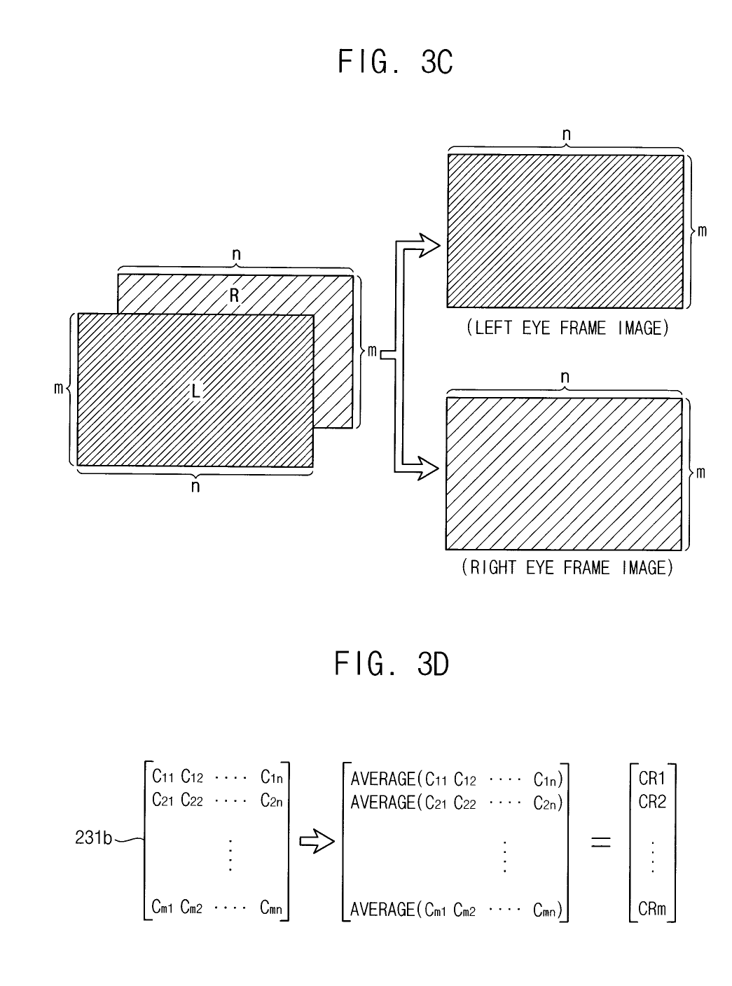

FIGS. 3A to 3D are schematic diagrams showing various driving examples of the exemplary embodiment of a dividing part 210 of FIG. 1.

Referring to FIGS. 1, 3A and 3B, in the present exemplary embodiment the dividing part 210 divides the input image having the resolution of (n×m) into the compression left-eye image LCI having a resolution of (n×e) and a compression right-eye image RCI having a resolution of (n×e). Wherein, n, m, k and e are natural number, k is n/2 and e is m/2. As shown in FIG. 3A, the input image includes a compression left-eye image LCI and a compression right-eye image RCI compressed by the horizontal interleave method, the top-bottom method or the checker method. In such an exemplary embodiment, each of the compression left-eye image LCI and the compression right-eye image RCI may be compressed in a vertical direction.

The comparison-estimation part 230 obtains a grayscale difference matrix 231a of (e×n) using the grayscale of the compression left-eye image LCI and the grayscale of the compression right-eye image RCI. The comparison-estimation part 230 obtains e crosstalk values CR1, CR2, . . . , CRe. Each of the crosstalk values CR1, CR2,. . . , CRe is an average value of grayscale differences in each of the rows of the grayscale difference matrix 231a. The comparison-estimation part 230 estimates a position at which the crosstalk is generated at a greatest level due to the grayscale difference between the left-eye composition image LCI and the right-eye composition image RCI among the first, second and third positions UP, MD and LW of the display panel 400 using e crosstalk values CR1, CR2, . . . , CRe.

Referring to FIGS. 1, 3C and 3D, the dividing part 210 receives the left-eye image L and the right-eye image R having the resolution of (n×m) at a high frame rate, e.g., the frames are input at a high frequency. In such an exemplary embodiment, the dividing part 210 sequentially provides the left-eye image L and the right-eye image R to the comparison-estimation part 230.

The comparison-estimation part 230 obtains a grayscale difference matrix 231b of (n×m) using the grayscale of the left-eye image L and the grayscale of the right-eye image R. The comparison-estimation part obtains m crosstalk values CR1, CR2, . . . , CRm. Each of the crosstalk values CR1, CR2, . . . , CRm is an average value of grayscale differences included in each of rows of the grayscale difference matrixes 231b of (n×m). The comparison-estimation part 230 estimates a position at which the crosstalk is greatest due to the grayscale difference between each of the left-eye images L and each of the right-eye images R among the first, second and third positions UP, MD and LW of the display panel 400 using m crosstalk values CR1, CR2, . . . , CRm.

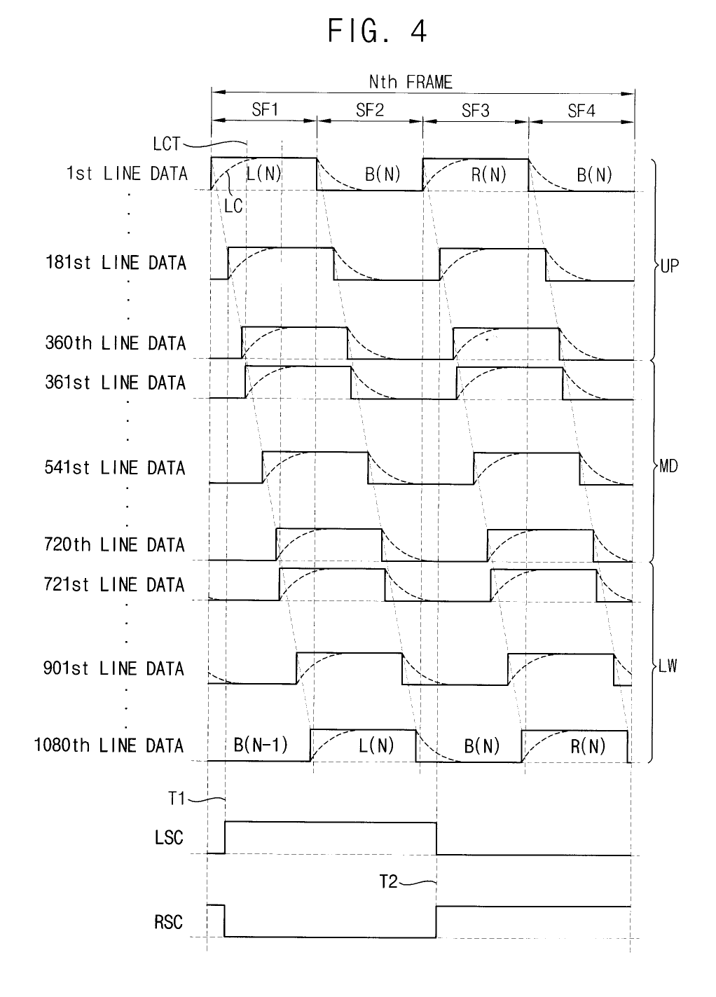

FIG. 4 is a timing diagram illustrating an exemplary embodiment of a method of displaying the stereoscopic image when the greatest amount of crosstalk is generated in the first portion of the display panel shown in FIG. 1.

Referring to FIGS. 1 and 4, the exemplary embodiment of a display panel 400 has the resolution of 1920×1080. The display panel 400 displays the left-eye frame image L for the first sub-frame SF1 (e.g., for about the first 4 ms) of the frame (e.g., wherein the frame is about 16 ms), displays the black frame image B for the second sub-frame SF2 (e.g., again about 4 ms) of the frame, displays the right-eye frame image R for the third sub-frame SF3 (e.g., again about 4 ms) of the frame and displays the black frame image B for the fourth sub-frame SF4 (e.g., again about 4 ms) of the frame. Alternative exemplary embodiments include configurations wherein the sub-frames are not equally divided temporally across a frame.

The display panel 400 displays a horizontal line image during a period that is later than a period during which a horizontal line data is applied to a horizontal line of the display panel 400 according to the response time of the liquid crystal. For example, in the first sub-frame SF1, a first horizontal line applied with a first horizontal line data of the left-eye frame image displays a grayscale image corresponding to the first horizontal line data after a timing LCT at which a 361^{st} horizontal line data is applied to a 361^{st} horizontal line.

For example, the display panel 400 displays a left-eye frame image L(N) and a right-eye frame image R(N) of an N-th frame through the progressive scan method. During the first sub-frame SF1 of the N-th frame, a left-eye image data corresponding to the left-eye frame image L(N) is sequentially applied to 1080 horizontal lines of the display panel 400. During the second sub-frame SF2 of the N-th frame, a black image data corresponding to the black image B(N) is sequentially applied to the 1080 horizontal lines. During the third sub-frame SF3 of the N-th frame, a right-eye image data corresponding to the right-eye fame image R(N) is sequentially applied to the 1080 horizontal lines. During the fourth sub-frame SF4 of the N-th frame, the black image data corresponding to the black image B(N) is sequentially applied to the 1080 horizontal lines.

The comparison-estimation part 230 estimates the position of the display panel 400 at which the greatest amount of crosstalk is generated, using the grayscale difference between the left-eye frame image L(N) and the right-eye frame image R(N) of the N-th frame.

When the first position UP of the display panel 400 is estimated to generate the most crosstalk, the shutter glasses 100 opens the left shutter 110 and closes the right shutter 130 in synchronization with displaying the left-eye image on the first position UP according to a control of the comparison-estimation part 230.

For example, the shutter glasses 100 open the left shutter 110 in response to a left shutter control signal LSC in synchronization with a first timing T1 at which a 181^{st} horizontal line data of the left-eye frame image L(N) is applied to a 181^{st} horizontal line that is substantially located to a center of the first position UP, e.g., midway between the first line of the first position UP and the first line of the second position MD. The shutter glasses 100 close the right shutter 130 in response to a right shutter control signal RSC in synchronization with the first timing T1. For two consecutive sub-frames (e.g., a time period of about 8 ms), the left shutter 110 is opened, and the right shutter 130 is closed. Thus, the viewer may view the left-eye frame image L(N) and the black frame image B(N) through the left shutter 110.

After this, the shutter glasses 100 open the right shutter 130 in response to the right shutter control signal RSC in synchronization with a second timing T2 at which the 181^{st} horizontal line data of the right-eye frame image R(N) is applied to the 181^{st} horizontal line that is substantially located to the center of the first position UP. The shutter glasses 100 open the left shutter 110 in response to the left shutter control signal LSC in synchronization with the second timing T2. For two consecutive sub-frames (e.g., about 8 ms), the right shutter 130 is opened, and the left shutter 110 is closed. Thus, the viewer may view the right-eye frame image R(N) and the black frame image B(N) through the right shutter 130.

Therefore, when the left-eye image is displayed on the first position UP that has the greatest amount of crosstalk due to the grayscale difference between each of the left-eye frame images L(N) and each of the right-eye frame images R(N) of the N-th frame, the viewer views the left-eye frame image L(N) through the left shutter 110. In addition, when the right-eye image is displayed on the first position UP that has the greatest amount of crosstalk due to the grayscale difference between each of the left-eye frame images L(N) and each of the right-eye frame images R(N) of the N-th frame, the viewer views the right-eye frame image R(N) through the left shutter 130. Thus, the crosstalk being viewed by the viewer may be decreased.

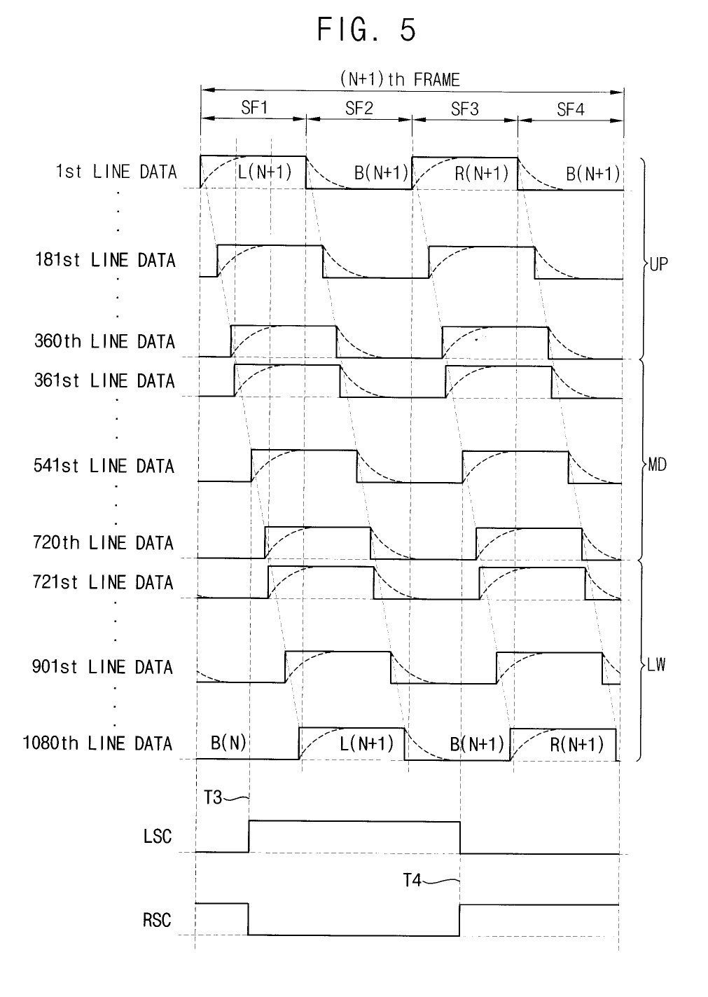

FIG. 5 is a timing diagram illustrating an exemplary embodiment of a method of displaying the stereoscopic image when the crosstalk is greatest in the second portion of the display panel shown in FIG. 1.

Referring to FIGS. 1 and 5, the display panel 400 displays a left-eye frame image L(N+1) and a right-eye frame image R(N+1) of an (N+1)-th frame generated by the progressive scan method. During the first sub-frame SF1 of the (N+1)-th frame, a left-eye image data corresponding to the left-eye fame image L(N+1) is sequentially applied to 1080 horizontal lines of the display panel 400. During the second sub-frame SF2 of the (N+1)-th frame, the black image data corresponding to the black frame image B(N+1) is sequentially applied to the 1080 horizontal lines. During the third sub-frame SF3 of the (N+1)-th frame, a right-eye image data corresponding to the right-eye fame image R(N+1) is sequentially applied to the 1080 horizontal lines. During the fourth sub-frame SF4 of the (N+1)-th frame, the black image data corresponding to the black frame image B(N+1) is sequentially applied to the 1080 horizontal lines.

The comparison-estimation part 230 estimates the position of the display panel 400 at which the greatest amount of crosstalk is generated, using the grayscale difference between each of the left-eye frame images L(N+1) and each of the right-eye frame images R(N+1) of the (N+1)-th frame.

When the second position MD of the display panel 400 is estimated to generate the greatest amount of crosstalk, the shutter glasses 100 open the left shutter 110 and close the right shutter 130 in synchronization with displaying the left-eye image on the second position MD according to a control of the comparison-estimation part 230.

For example, the shutter glasses 100 open the left shutter 110 in response to the left shutter control signal LSC in synchronization with a third timing T3 at which a 541^{st} horizontal line data of the left-eye frame image L(N+1) is applied to a 541^{st} horizontal line that is substantially located at a center of the second position MD, e.g., at a midpoint between the last line of the first portion UP and a first line of the third portion LW. The shutter glasses 100 close the right shutter 130 in response to the right shutter control signal RSC in synchronization with the third timing T3. For two consecutive sub-frames (e.g., about 8 ms), the left shutter 110 is opened, and the right shutter 130 is closed. Thus, the viewer may view the left-eye frame image L(N+1) and the black frame image B(N+1) through the left shutter 110.

Then, the shutter glasses 100 open the right shutter 130 in response to the right shutter control signal RSC in synchronization with a fourth timing T4 at which the 541^{st} horizontal line data of the right-eye frame image R(N+1) is applied to the 541^{st} horizontal line that is substantially located to the center of the second position MD. The shutter glasses 100 open the left shutter 110 in response to the left shutter control signal LSC in synchronization with the fourth timing T4. For two consecutive sub-frames (e.g., about 8 ms), the right shutter 130 is opened, and the left shutter 110 is closed. Thus, the viewer may view the right-eye frame image R(N+1) and the black frame image B(N+1) through the right shutter 130.

Therefore, when the left-eye image is displayed on the second position MD that has the greatest amount of crosstalk due to the grayscale difference between the left-eye frame image L(N+1) and the right-eye frame image R(N+1) of the (N+1)-th frame, the viewer views the left-eye frame image L(N+1) through the left shutter 110. In addition, when the right-eye image is displayed on the second position MD that has the greatest amount of crosstalk due to the grayscale difference between the left-eye frame image L(N+1) and each of the right-eye frame image R(N+1) of the (N+1)-th frame, the viewer views the right-eye frame image R(N+1) through the left shutter 130. Thus, the crosstalk viewed by the viewer may be decreased.

In addition, when the crosstalk due to the grayscale difference between each of the left-eye frame images L(N+1) and each of the right-eye frame images R(N+1) of the (N+1)-th frame, is uniform in the first to third positions UP, MD and LW of the display panel 400, the shutter glasses 100 open the left shutter 110 and close the right shutter 130 in response to the left shutter control signal LSC in synchronization with the third timing T3 at which the 541^{st} horizontal line data of the left-eye frame image L(N+1) is applied to the 541^{st} horizontal line that is substantially located to a center of the display panel 400. Thereafter, the shutter glasses 100 open the right shutter 130 and the left shutter 110 in response to the right shutter control signal RSC in synchronization with the fourth timing T4 at which the 541^{st} horizontal line data of the right-eye frame image R(N+1) is applied to the 541^{st} horizontal line. Thus, the crosstalk viewed by the viewer may be decreased.

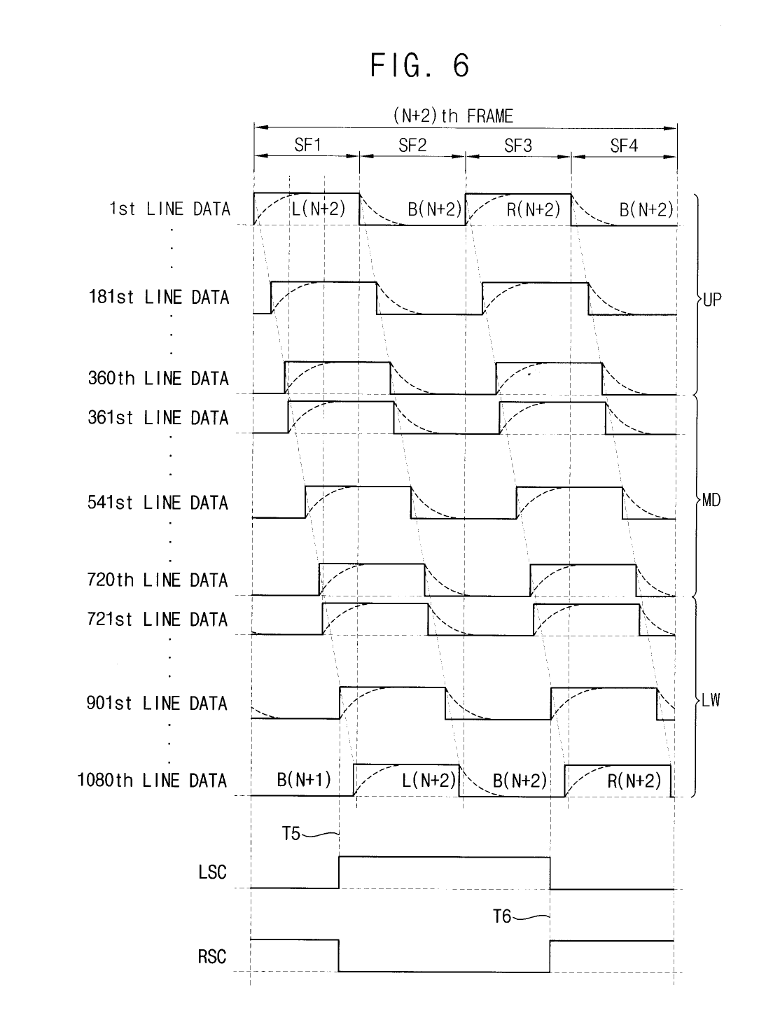

FIG. 6 is a timing diagram illustrating an exemplary embodiment of a method of displaying the stereoscopic image when the greatest amount of crosstalk is generated in the third portion of the display panel shown in FIG. 1.

Referring to FIGS. 1 and 6, the display panel 400 displays a left-eye frame image L(N+2) and a right-eye frame image R(N+2) of an (N+2)-th frame through the progressive scan method. During the first sub-frame SF1 of the (N+2)-th frame, a left-eye image data corresponding to the left-eye fame image L(N+2) is sequentially applied to 1080 horizontal lines of the display panel 400. During the second sub-frame SF2 of the (N+2)-th frame, the black image data corresponding to the black frame image B(N+2) is sequentially applied to the 1080 horizontal lines. During the third sub-frame SF3 of the (N+2)-th frame, a right-eye image data corresponding to the right-eye fame image R(N+2) is sequentially applied to the 1080 horizontal lines. During the fourth sub-frame SF4 of the (N+2)-th frame, the black image data corresponding to the black frame image B(N+2) is sequentially applied to the 1080 horizontal lines.

The comparison-estimation part 230 estimates that the third position LW of the display panel 400 has the greatest amount of crosstalk due to the grayscale difference between each of the left-eye frame images L(N+2) and each of the right-eye frame images R(N+2) of the (N+2)-th frame. When the third position LW of the display panel 400 is estimated to have the greatest amount of crosstalk, the shutter glasses 100 open the left shutter 110 and close the right shutter 130 in synchronization with displaying the left-eye image on the third position LW according to a control of the comparison-estimation part 230.

For example, the shutter glasses 100 open the left shutter 110 in response to the left shutter control signal LSC in synchronization with a fifth timing T5 at which a 901^{st} horizontal line data of the left-eye frame image L(N+2) is applied to a 901^{st} horizontal line that is substantially located to the center of the third position LW, e.g., midway between a first line of the third portion LW and a final line of the third portion LW. The shutter glasses 100 close the right shutter 130 in response to the right shutter control signal RSC in synchronization with the fifth timing T5. For two consecutive sub-frames (e.g., about 8 ms), the left shutter 110 is opened, and the right shutter 130 is closed. Thus, the viewer may view the left-eye frame image L(N+2) and the black frame image B(N+2) through the left shutter 110.

After this, the shutter glasses 100 open the right shutter 130 in response to the right shutter control signal RSC in synchronization with a sixth timing T6 at which the 901^{st} horizontal line data of the right-eye frame image R(N+2) is applied to the 901^{st} horizontal line that is substantially located to the center of the third position LW. The shutter glasses 100 open the left shutter 110 in response to the left shutter control signal LSC in synchronization with the sixth timing T6. For two consecutive sub-frames (e.g., about 8 ms), the right shutter 130 is opened, and the left shutter 110 is closed. Thus, the viewer may view the right-eye frame image R(N+2) and the black frame image B(N+2) through the right shutter 130.

Therefore, when the left-eye image is displayed on the third position LW that has the greatest amount of crosstalk due to the grayscale difference between each of the left-eye frame images L(N+2) and each of the right-eye frame images R(N+2) of the (N+2)-th frame, the viewer views the left-eye frame image L(N+2) through the left shutter 110. In addition, when the right-eye image is displayed on the third position LW that has the most crosstalk by the grayscale difference between each of the left-eye frame images L(N+2) and each of the right-eye frame images R(N+2) of the (N+2)-th frame, the viewer views the right-eye frame image R(N+2) through the left shutter 130. Thus, the crosstalk viewed by the viewer may be decreased.

As a result, the crosstalk is estimated in real time using the grayscale difference between the right-eye image and the right-eye image, and the opening and closing periods of the shutter glasses 100 are controlled based on the estimated crosstalk. Thus, the crosstalk of the stereoscopic image may be decreased.

As described above, the crosstalk due to the grayscale difference between the left-eye frame image and the right-eye frame image is estimated according to the position of the display panel and the opening and closing periods of the shutter is controlled based on the estimated crosstalk so that the crosstalk viewed by the viewer may be decreased.

The foregoing is illustrative of the present invention and is not to be construed as limiting thereof Although a few example embodiments of the present invention have been described, those skilled in the art will readily appreciate that many modifications are possible in the example embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific example embodiments disclosed, and that modifications to the disclosed example embodiments, as well as other example embodiments, are intended to be included within the scope of the appended claims. The present invention is defined by the following claims, with equivalents of the claims to be included therein.

What is claimed is:

1. A method of displaying a stereoscopic image, the method comprising:
dividing an input image into a left-eye image and a right-eye image;
estimating a crosstalk in accordance with a position of a display panel using a grayscale difference between the left-eye image and the right-eye image;
displaying the left-eye image and the right-eye image; and
adjusting opening periods and closing periods of a pair of shutter glasses so that a shutter of the shutter glasses is open and closed, respectively, during the opening periods and the closing periods based on the estimated crosstalk.

2. The method of claim 1, wherein estimating the crosstalk in accordance with the position of the display panel comprises:
obtaining a grayscale difference matrix using a difference between grayscale values of the left-eye image and grayscale values of the right-eye image;
obtaining a plurality of crosstalk values, wherein each of the plurality of crosstalk values is an average of values in a row of the grayscale difference matrix; and
comparing each of the plurality of crosstalk values with a reference value to estimate the crosstalk at the position corresponding to the crosstalk value.

3. The method of claim 1, further comprising:
displaying the left-eye image on the display panel during a first sub-frame of a frame;
displaying a black image on the display panel during a second sub-frame which is consecutive to the first sub-frame of the frame;
displaying the right-eye image on the display panel during a third sub-frame which is consecutive to the second sub-frame of the frame; and
displaying the black image on the display panel during a fourth sub-frame which is consecutive to the third sub-frame of the frame.

4. The method of claim 3, wherein adjusting the opening period and closing period of the pair of shutter glasses comprises:
opening a left shutter and closing a right shutter in synchronization with displaying the left-eye image on a position of the display panel which generates the greatest estimated crosstalk; and
opening the right shutter and closing the left shutter in synchronization with displaying the right-eye image on the position of the display panel which generates the greatest estimated crosstalk.

5. The method of claim 4, wherein adjusting the opening period and the closing period of the pair of shutter glasses comprises:
opening the left shutter and closing the right shutter in synchronization with a first period, wherein the display panel is divided into a first position, a second position and a third position along an image scanning direction of the display panel, and wherein data of the left-eye image is applied to a central horizontal line of the first position during the first period when the greatest estimated crosstalk is generated at the first position; and
opening the right shutter and closing the left shutter in synchronization with a second period, wherein data of the right-eye image is applied to the central horizontal line of the first position during the second period.

6. The method of claim 4, wherein adjusting the opening period and the closing period of the pair of shutter glasses comprises:
opening the left shutter and closing the right shutter in synchronization with a third period, the display panel being divided into a first position, a second position and a third position along an image scanning direction of the display panel, and wherein data of the left-eye image is applied to a central horizontal line of the second position during the third period when the greatest estimated crosstalk is generated at the second position; and
opening the right shutter and closing the left shutter in synchronization with a fourth period, wherein data of the right-eye image is applied to the central horizontal line of the second position during the fourth period.

7. The method of claim 4, wherein adjusting the opening period and the closing period of the pair of shutter glasses comprises:
opening the left shutter and closing the right shutter in synchronization with a fifth period, the display panel being divided into a first position, a second position and a third position along an image scanning direction of the display panel, and wherein data of the left-eye image is applied to a central horizontal line of the third position during the fifth period when the greatest estimated crosstalk is generated at the third position; and
opening the right shutter and closing the left shutter in synchronization with a sixth period, wherein data of the right-eye image is applied to the central horizontal line of the third position during the sixth period.

8. The method of claim 3, wherein when the crosstalk is uniformly distributed over the display panel, adjusting the opening period and the closing period comprises:
opening a left shutter and closing a right shutter in synchronization with a first period, wherein data of the left-eye image is applied to a central horizontal line of the display panel during the first period; and
opening the right shutter and closing the left shutter in synchronization with a second period, wherein data of the right-eye image is applied to the central horizontal line of the display panel during the second period.

9. The method of claim 1, further comprising:
scaling each of the left-eye image and the right-eye image in accordance with a resolution of the display panel.

10. A display apparatus comprising:
a display panel displaying a left-eye image and a right-eye image;
a pair of shutter glasses including a left shutter and a right shutter, wherein the pair of shutter glasses selectively opens and closes the left shutter and the right shutter according to an image displayed on the display panel; and
a stereoscopic image converting part which divides an input image into the left-eye image and the right-eye image, estimates a crosstalk in accordance with a position of the display panel using a grayscale difference between the left-eye image and the right-eye image, and adjusts an opening period and a closing period of the left shutter and the right shutter based on the estimated crosstalk.

11. The display apparatus of claim 10, wherein the stereoscopic image converting part comprises:
a dividing part which divides an input image into the left-eye image and the right-eye image; and
a comparison-estimation part which obtains a grayscale difference matrix using a difference between grayscale values of the left-eye image and grayscale values of the right-eye image, obtains a plurality of crosstalk values, wherein each of the plurality of crosstalk values is an average of values in a row of the grayscale difference matrix, and compares each of the crosstalk values with a reference value to estimate the crosstalk at the position.

12. The display apparatus of claim 10, further comprising:
a timing control part which controls a black image to be inserted between the left-eye image and the right-eye image.

13. The display apparatus of claim 10, wherein the stereoscopic image converting part further comprises:
a scaling part which scales the left-eye image and the right-eye image in accordance with a resolution of the display panel; and
a reconstruction part which divides the left-eye image into a first sub-left-eye image and a second sub-left-eye image respectively corresponding to a first area of the display panel and a second area of the display panel, divides the right-eye image into a first sub-right-eye image and a second sub-right-eye image respectively corresponding to the first area and the second area, and groups the first sub-left-eye image with the first sub-right-eye image together and groups the second sub-left-eye image with the second sub-right-eye image together.

14. The display apparatus of claim 10, further comprising:
a data driving part which displays the left-eye image on the display panel during a first sub-frame of a frame, displays a black image on the display panel during a second sub-frame which is consecutive to the first sub-frame of the frame, displays the right-eye image on the display panel during a third sub-frame which is consecutive to the second sub-frame of the frame, and displays the black image on the display panel during a fourth sub-frame which is consecutive to the third sub-frame of the frame.

15. The display apparatus of claim 14, wherein the data driving part includes a first data driving circuit which displays the first sub left-eye image and the first sub right-eye image on the first area of the display panel and a second data driving circuit which displays the second sub left-eye image and the second sub right-eye image on the second area of the display panel.

16. The display apparatus of claim 10, wherein the comparison-estimation part opens the left shutter and closes the right shutter when the left-eye image is displayed on the position of the display panel where the greatest estimated crosstalk is generated, and opens the right shutter and closes the left shutter when the right-eye image is displayed on the position of the display panel where the greatest estimated crosstalk is generated.

17. The display apparatus of claim 16, wherein the display panel is divided into a first position, a second position and a third position along an image scanning direction of the display panel,
wherein the comparison-estimation part opens the left shutter and closes the right shutter in synchronization with a first period, and data of the left-eye image is applied to a central horizontal line of the first position during the first period when the greatest estimated crosstalk is generated at the first position,
wherein the comparison-estimation part opens the right shutter and closes the left shutter in synchronization with a second period, and data of the right-eye image is applied to the central horizontal line of the first position during the second period.

18. The display apparatus of claim 16, wherein the display panel is divided into a first position, a second position and a third position along an image scanning direction of the display panel,
wherein the comparison-estimation part opens the left shutter and closes the right shutter in synchronization with a third period, and data of the left-eye image is applied to a central horizontal line of the second position during the third period when the greatest estimated crosstalk is generated at the second position,
wherein the comparison-estimation part opens the right shutter and closes the left shutter in synchronization with a fourth period, and data of the right-eye image is applied to the central horizontal line of the second position during the fourth period.

19. The display apparatus of claim 16, wherein the display panel is divided into a first position, a second position and a third position along an image scanning direction,
wherein the comparison-estimation part opens the left shutter and closes the right shutter in synchronization with a fifth period, and data of the left-eye image is applied to a central horizontal line of the third position during the fifth period when the greatest estimated crosstalk is generated at the third position,
wherein the comparison-estimation part opens the right shutter and closes the left shutter in synchronization with a sixth period, and data of the right-eye image is applied to the central horizontal line of the third position during the sixth period.

20. The display apparatus of claim 14, wherein when the crosstalk is uniformly distributed over the display panel, the comparison-estimation part opens the left shutter and closes the right shutter in synchronization with a first period, and data of the left-eye image is applied to a central horizontal line of the display panel during the first period,
wherein when the crosstalk is uniformly distributed over the display panel, the comparison-estimation part opens the right shutter and closes the left shutter in synchronization with a second period, and data of the right-eye image is applied to the central horizontal line of the display panel during the second period.
